(19) United States
(12) Patent Application Publication
(10) Pub. No.: US 2026/0184891 A1
(43) Pub. Date: Jul. 2, 2026

(54) COATING WITH IMPROVED SLIDING AND FIRE RESISTANCE PROPERTIES AND USES THEREOF

(71) Applicant: Conductores Monterrey S.A. de C.V., San Nicolás de los Garza (MX)

(72) Inventors: Cesar Nadem MUÑOZ LOPEZ, San Nicolás De Los Garza (MX); Cecilia Giovana CASTILLO SOSA, San Nicolás De Los Garza (MX); Juan Agustín ARROYO CABALLERO, San Nicolás De Los Garza (MX); Arturo GARCÍA REYNA, San Nicolás De Los Garza (MX)

(21) Appl. No.: 19/433,428

(22) Filed: Dec. 26, 2025

Related U.S. Application Data
(60) Provisional application No. 63/739,321, filed on Dec. 27, 2024.

(51) Int. Cl. C08K 5/12; B29C 48/154; B29C 48/36; B29K 27/06; B29L 31/34; C08K 3/08; C08K 3/22; C08K 3/34; C08K 5/00; C08K 5/098; C08K 5/521

(52) U.S. Cl. CPC C08K 5/12; B29C 48/154; B29C 48/36; C08K 3/2279; C08K 3/34; C08K 5/0016; C08K 5/0066; C08K 5/098; C08K 5/521; B29K 2027/06; B29K 2995/0016; B29L 2031/3462; C08K 2003/0812; C08K 2003/2227

(57) ABSTRACT

The present invention relates to a thermoplastic coating for medium-voltage cables, specifically designed to improve both their sliding properties and fire resistance. This innovative coating solution addresses the technical problem of fire spread in the event of ignition near or on the cable, while minimizing the time and effort required for cable installation. The invention utilizes a unique formulation of PVC compounds, incorporating non-halogenated alkyl aryl flame-retardant plasticizers, along with a combination of flame retardants such as magnesium hydroxide (MDH), aluminum trihydrate (ATH), and sepiolite-based flame retardants. Additionally, high-energy light stabilizers (HALS) are included to protect the cable from degradation over time. The overall result is a coating that provides effective fire resistance, reduces friction, and significantly simplifies installation. The system works by preventing the spread of fire and ensuring that cables can be easily inserted into electrical conduits, even in challenging environments.

### CROSS-REFERENCE TO RELATED APPLICATIONS

This application claims priority from U.S. provisional Application No. 63/739,321, filed on Dec. 27, 2024, which application is hereby incorporated in its entirety by reference in this application.

### FIELD OF INVENTION

The present invention relates, in general, to a thermoplastic coating for medium voltage cables that offers improved sliding properties and fire resistance (FT4 classification).

### BACKGROUND OF THE INVENTION

Installing medium-voltage cables in narrow, confined spaces presents significant challenges to current technologies. Installers often struggle to efficiently slide cables through tight conduits, which can lead to increased installation times and labor costs. Furthermore, these installations are susceptible to fire hazards, particularly in the event of ignition, where the potential for fire spread can jeopardize the safety of the entire electrical system.

Presently, the growing demand for safer and more efficient electrical systems has highlighted the limitations of conventional technologies and materials used in medium-voltage cable installations. This increased demand is partly due to the expansion of electrical networks in urban areas and the need to optimize space utilization in increasingly congested environments. Installing cables in space-constrained environments presents significant technical challenges, as traditional methods have not kept pace with modern efficiency and safety requirements.

In particular, installation in small and confined spaces presents a significant challenge for the industry, as installers must overcome difficulties in sliding cables through narrow conduits and ducts. Excessive friction between the cable surface and the conduit interior can generate several problems, such as increased installation time, as the difficulty in passing the cable without damaging it forces slower processes, directly impacting higher labor costs and prolonging project execution times; risk of mechanical damage, since the additional effort required to move the cable can cause abrasions or micro-damage to the insulating jacket, weakening the cable's integrity and potentially leading to future failures; and accelerated material wear, as repeated friction affects not only the cable but also the internal surfaces of the ducts and conduits, which can result in the need for more frequent maintenance or premature replacement of these components.

Furthermore, another crucial technical problem lies in the high vulnerability of conventional installations to fire. Exposure to extreme conditions or ignition sources in the vicinity of the cable can trigger fires that, in the absence of adequate protective measures, spread rapidly and uncontrollably.

When ignition occurs, whether near or directly on a cable, the fire has the potential to spread rapidly throughout the cable network, compromising the safety of the entire electrical installation. In this sense, a fire that spreads through the cables not only affects an insulated component but can trigger cascading failures, impacting sensitive equipment and jeopardizing the overall infrastructure.

In general, the technical problems arising from the installation of medium-voltage cables in confined spaces and their vulnerability to fire constitute challenges that affect both the operability and safety of modern electrical installations. The need to overcome these drawbacks drives the search for and development of innovative materials that reduce friction during installation and, in turn, offer robust fire protection, thus ensuring a safer, more reliable, and more efficient electrical system. This remains a constant challenge within the technological field.

With reference to current technologies, it is notable that current coatings do not effectively combine optimal sliding properties with high fire resistance, mainly due to the absence of materials that integrate both characteristics, since improvement in one aspect is not usually accompanied by advances in the other, leaving the industry without a complete solution that simultaneously addresses installation efficiency and operational safety.

As an example, Chinese patent No. CN114446532B, published on May 6, 2022, discloses a method for producing medium-voltage cable with fire-resistant properties. The document describes the formulation of polymer compounds that include flame-retardant additives, the mixing of raw materials, and the application of extrusion processes and controlled heat treatment to obtain a cable structure that meets regulatory requirements under fire conditions. Specific parameters for temperature, extrusion speed, and curing times are detailed, as well as quality control techniques during manufacturing, ensuring the homogeneous distribution of additives within the matrix and the integrity of the cable's insulating and protective layers.

Additionally, Chinese patent No. CN117577384B, published on Feb. 20, 2024, is known, whose teachings focus on obtaining a flame-resistant cable through the integration of multiple layers of polymeric materials formulated with specific properties to inhibit flame propagation. The document details the selection of internal and external coatings, which incorporate flame-retardant and insulating compounds, and describes lamination and extrusion processes that ensure homogeneous bonding between the different layers. It also specifies the processing conditions, such as extrusion temperatures and pressures, necessary to maintain structural integrity and chemical compatibility between the layers, so that the cable behaves in a controlled manner under prolonged exposure to fire.

Furthermore, within the prior art, US Patent No. U.S. Pat. No. 10,825,580B2, published on Nov. 8, 2018, it is also known, which discloses compositions for compounding, extrusion, and melt processing of halogen-free polymers capable of forming foam and cellular structures. This document details formulations that combine a base polymer with foaming and stabilizing agents, enabling the controlled generation of cells or bubbles within the polymer matrix during the extrusion process. It also describes processing parameters, such as melt temperature, cooling profile, and extrusion speed, that influence the final morphology of the material, as well as the incorporation of additives that promote uniform cell distribution without affecting the mechanical properties of the final product.

On the other hand, US Patent No. U.S. Pat. No. 11,393,609B2, published on Apr. 16, 2020, describes an electrical cable incorporating a flame-retardant composite formulation designed to limit fire spread and minimize smoke emission, while maintaining flexibility and performance properties under low-temperature conditions. The document details the composition of each cable layer, including coatings and insulating materials manufactured through extrusion and thermal forming processes, and specifies the technical processing conditions necessary for the stable integration of the various materials. Furthermore, it describes laboratory tests that verify the cable's response to thermal and mechanical variations, providing a framework for its compliance with current regulations.

Furthermore, the publication entitled “Fire Testing of Medium-Voltage Cables. Classes According to CPR Regulations,” by PRYSMIAN CLUB, publicly available since Sep. 3, 2021, reveals a technical analysis of the experimental procedures applied to medium-voltage cables to evaluate their fire performance. The document describes in detail the testing methodology, in which parameters such as flame spread, smoke generation, and structural integrity are measured during and after fire exposure, according to the criteria established in the CPR Regulations. The test conditions are specified, including the type of fuel, the duration of the tests, and the environmental conditions, as well as the methods for measuring and controlling critical variables, providing a technical basis for the classification and safety assessment of cables in specific applications.

Based on the teachings learned from the prior art, it is clear that, to date, there are various attempts to improve specific aspects, such as fire resistance or cable stability, but none comprehensively address the dual need to facilitate efficient cable sliding in narrow conduits and, simultaneously, mitigate the risks of fire spread in electrical installations.

As previously mentioned, the installation of medium-voltage cables in confined spaces continues to present significant challenges for the electrical industry. In practice, installers face situations where excessive friction between the cable and the interior of narrow ducts and conduits results in significantly increased installation time, leading to higher labor costs, an increased risk of mechanical damage to the cable jacket, which can compromise system integrity and reduce its lifespan, and potential damage to installation materials, necessitating premature maintenance or replacement.; furthermore, the fire vulnerability of conventional materials exacerbates the problem, since in ignition scenarios, whether in the immediate vicinity of the cable or on the cable itself, the lack of effective fireproofing allows the fire to spread rapidly and uncontrollably, compromising the safety not only of the installation but also of the people and equipment involved.

Therefore, there is a need to develop a means capable of providing a voltage cable with a significantly reduced coefficient of friction to facilitate cable sliding in confined spaces, thus optimizing the installation process and reducing operating costs, as well as high fire resistance that prevents the spread of flames in case of ignition, guaranteeing the integrity and safety of the entire electrical network, achieving both effects simultaneously, without altering or compromising other desirable properties of the cable.

### SUMMARY OF THE INVENTION

It is therefore an objective of the present invention to provide a coating for voltage cables that, through the integration of a specific formulation based on PVC resin and a specific combination of additives, significantly improves fire resistance and, at the same time, offers superior sliding properties.

By “improving fire resistance and at the same time offering superior sliding properties” it shall be understood that the present invention provides a coating with sliding properties that facilitate the installation of cables in narrow conduits and ducts, achieving a smoother movement and significantly reducing the time and effort required during the installation process and at the same time increasing durability and thermal stability, ensuring that the material retains its physical and chemical properties during processing and throughout its useful life, even under conditions of high or fluctuating temperatures, which is fundamental to guaranteeing the integrity and reliability of electrical installations.

On the other hand, a particular objective of the present invention is to provide a coating that is a thermoplastic coating, applicable to medium voltage cables.

In general, the present invention provides a coating for voltage cables that significantly improves both sliding properties and fire resistance, thereby addressing the technical problems related to the efficient sliding of cables through narrow structures, while reducing the fire risks that can compromise the safety of electrical installations, where the proposed solution minimizes the risk of fire spread in case of ignition near or on the cable, while offering a practical solution to reduce installation time and effort.

In a preferred embodiment, the invention uses a non-halogenated flame-retardant plasticizer, particularly based on alkyl aryl compounds, which is a significant innovation compared to the prior art since it provides superior fire resistance compared to traditional halogenated flame retardants, significantly reducing the risks associated with fire spread in the event of ignition.

It is also noteworthy that the synergistic effect of magnesium hydroxide (MDH), aluminum oxide base, aluminum trihydrate (ATH), and a functionalized sepiolite base further enhance the flame-retardant properties of the thermoplastic coating, wherein these additives work together with the other components of the formulation to ensure that the fire is effectively contained and does not spread along the cable, thus ensuring both the protection of the installation and the safety of its surroundings.

Another objective of the present invention is to provide sliding properties by selecting and combining additives, including a low molecular weight polyethylene polymer and epoxidized soybean oil, components that significantly reduce the coefficient of friction, thus allowing the cable to which the coating is applied to slide more easily through narrow conduits and ducts, considerably decreasing installation time and effort.

Moreover, the aforementioned improvement represents a clear advantage over conventional cable coatings, in which high levels of friction often make installation difficult and increase the risk of damage to the cable or surrounding materials.

Furthermore, an objective of the present invention is to provide a coating that incorporates UV light stabilizers, specifically hindered amine light stabilizers (HALS), to provide long-lasting protection against degradation from UV exposure, a common problem in outdoor or weather-exposed cable installations.

In said embodiment where HALS are incorporated, the coating of the present invention is able to effectively prevent material degradation caused by prolonged exposure to sunlight, thus extending the cable's lifespan and maintaining its performance over time, adding significant value to the invention, especially in applications where cables are exposed to adverse environmental conditions.

Furthermore, another objective of the present invention is to provide a coating that incorporates a combination of antioxidants for plastic applications, which improves the thermal stability of the coating during its manufacture and throughout its operational life, also ensuring that the material remains stable and durable when exposed to high temperatures both in its processing and in its use, which contributes to the overall strength of the cable coating, making it suitable for environments where temperature fluctuations or excessive heat may pose a challenge.

### BRIEF DESCRIPTION OF THE FIGURES

FIG. 1 is a graph illustrating a flame test on a PVC thermoplastic jacket, showing FT4-type flame curves corresponding to the charring or carbonization formation for a 4/0 AWG cable with a thermoplastic PVC jacket.

FIG. 2 is a graph showing the FT4 flame category for electrical conductor cables for two different gauges (1/0 and 4/0 AWG) in halogenated thermoplastic polymeric jacket.

FIG. 3 is a graph illustrating the FT4 flame category for electrical conductor cables for different samples of halogenated thermoplastic polymer jacket in sizes 4/0 AWG).

FIG. 4 is a chart showing the FT4 type flame test for thermoplastic insulated PVC jacket for a 4/0 AWG gauge.

FIG. 5 is a graph illustrating the evaluation of the FT4 vertical tray cable test for thermoplastic jackets.

FIG. 6 shows the graph that displays the length of the char, as it is known in the cable industry and is a concept accepted by national and international standards on the subject.

FIG. 7 shows the length of the char, as it is known in the cable industry and is a concept accepted by national and international standards on the subject.

### DETAILED DESCRIPTION OF THE INVENTION

Some aspects of the present invention will now be described in more detail, also using reference to the accompanying drawings which show some embodiments and advantages of the present invention.

It will be evident to a person skilled in the art that various embodiments of the invention can be expressed in different ways and should not be interpreted as being limited to the embodiments described herein; rather, these exemplary embodiments are provided to make this invention clear and complete and to fully convey the scope of the invention to those skilled in the art. For example, unless otherwise indicated, something described as first, second, or similar should not be interpreted as a particular order. As used in the description and in the appended claims, the singular forms “a,” “an,” “the,” and “a” include plural referents unless the context clearly indicates otherwise.

The different aspects of the present invention relate to a thermoplastic coating for medium voltage cables that integrates a specific composition, designed to provide both a high degree of sliding during installation in narrow conduits and ducts and superior fire resistance, achieving FT4 classification and preventing the spread of flames in critical situations.

This solution arises from the pressing need to optimize the installation and safety of cables in electrical infrastructures, where reducing friction and mitigating the risk of fires are fundamental aspects to guarantee both operational efficiency and the protection of the integrity of the system.

The invention is based on the synergistic incorporation of compounds, obtaining a coating that significantly improves the mechanical, thermal, and sliding properties of the cable, ensuring optimal performance even under demanding conditions. It should be mentioned that the strategic combination of components, in its different embodiments described in this document, offers a result not previously achieved in the prior art, since, as previously mentioned in this application, existing efforts have not achieved a combination of components that achieves true synergy, comprehensively improving the effects, particularly flame resistance and friction reduction.

More particularly, the present invention provides an integral coating for voltage cables, which combines superior fire resistance, reduced friction for easier installation, and is also capable of offering improved durability against degradation from UV radiation.

By addressing key challenges in the field of electrical cable insulation, the present invention offers a solution that improves both safety and efficiency, while also ensuring the long-term reliability of the cables.

Furthermore, the present invention solves a technical challenge in the field of electrical installations, namely, the spread of fire in the event of an adjacent ignition source or direct contact with the cable. It also effectively reduces the time and effort required for cable installation, especially in confined spaces or narrow conduits, where typical installation procedures are often cumbersome.

The coating formulation, in any of the embodiments described in this application, is capable of providing optimal fire protection and improved installation efficiency. As a result, this invention offers both safety and practicality in real-world applications.

One of the key features of the invention is the use of a non-halogenated flame-retardant plasticizer, which reduces the flammability of the coating, effectively preventing the spread of fire if the cable is exposed to an ignition source; the inventors have demonstrated that the incorporation of this flame-retardant plasticizer is essential because it prevents the release of harmful halogenated gases commonly associated with halogenated flame retardants; this not only achieves a substantial improvement in fire safety but also eliminates environmental and health concerns typically associated with halogenated compounds, thus improving the overall fire resistance profile of the coating while ensuring that the material remains flexible and functional under high-temperature conditions.

Furthermore, the flame-retardant plasticizer enhances the structural integrity of the coating during prolonged exposure to high temperatures. The composition of the invention, in its various embodiments, ensures that the resulting coating does not degrade under elevated conditions, situations that can occur in electrical installations as well as in localized fires. This characteristic is particularly advantageous for cables used in industrial, commercial, and residential environments, where fire safety is paramount. The plasticizer not only optimizes the coating's flame retardancy but also contributes to its ability to withstand mechanical stress, thus extending the cable's lifespan and reliability.

The synergy between these components of the present invention, in their different embodiments, creates a highly effective fire retarding system, improving the fire resistance of the coating, improving overall mechanical strength, and resistance to degradation caused by prolonged exposure to ultraviolet (UV) radiation.

Regarding the improvement of overall mechanical strength, it is important to highlight that the coating of the present invention is able to improve the coefficient of friction of the cable to which it is applied, which facilitates the installation of cables, especially in confined spaces or narrow conduits.

The ability to effortlessly slide cables through tight spaces is a significant advantage in hard-to-reach environments such as ducts, wall cavities, or underground installations. By reducing friction, the coating allows for faster and more efficient installation, lowering labor costs and installation time. Furthermore, the low-friction properties minimize the risk of cable damage during installation, preserving insulation integrity and ensuring the cable performs as intended throughout its lifespan.

Reduced friction also contributes to safety during the installation process. In situations where cables are installed in complex or congested environments, the low-friction coating helps prevent cables from jamming or becoming trapped, which could cause delays or potential damage. This feature not only improves overall installation efficiency but also increases the safety of the workers involved by reducing the likelihood of accidents or injuries caused by cable entanglements or jams. The inclusion of a low-friction plasticizer makes the cable more versatile and adaptable to a variety of installation scenarios, increasing its appeal for multiple applications.

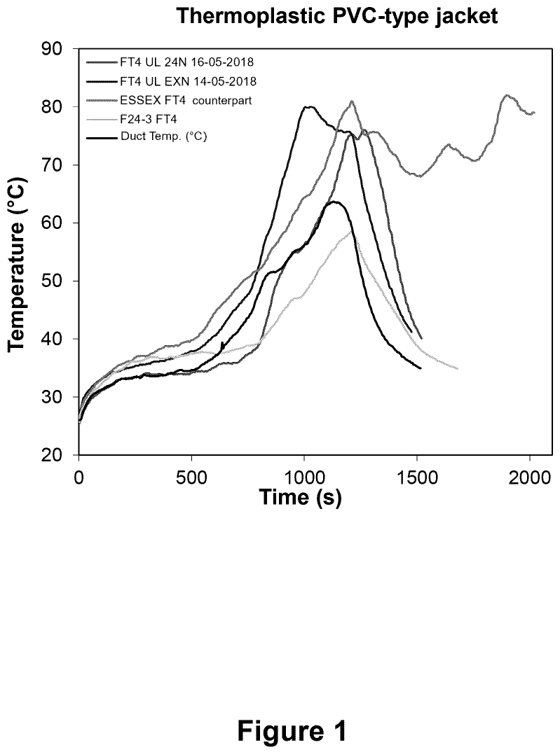

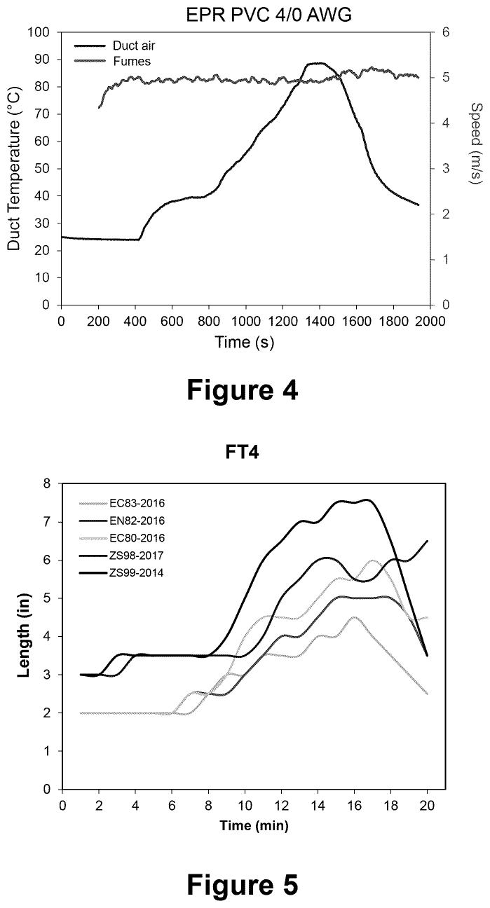

In a first embodiment of the present invention, and as can be seen in FIGS. 1-7, the coating of the present invention comprises:
A) At least one base resin, which constitutes the fundamental matrix that functions as the base structure on which the other additives are integrated.

In one embodiment, the at least one base resin is selected from a material with high rigidity, thermal stability and compatibility; more particularly, the at least one base resin is any matrix selected from the group comprising high-quality PVC, cross-linked polyethylene (XLPE), high-density polyethylene (HDPE), low-density polyethylene (LDPE), ethylene-vinyl acetate copolymers (EVA), technical polyamides, combinations thereof and/or similar materials.

Additionally, in one embodiment, the at least one base resin is present in concentrations ranging from 30 to 60% of the total formulation.

Moreover, in one embodiment, the at least one base resin comprises a viscosity in the range of 200 to 500 poises, as well as a density in the range of 1.2 to 1.5 g/cm³.

On the other hand, in an additional embodiment, the at least one base resin is characterized by sufficient purity capable of guaranteeing a uniform dispersion of the additives, ensuring optimal adhesion and adequate mechanical resistance during cable operation.

In this sense, “ensuring uniform dispersion of additives” refers to the ability of the base resin to homogeneously incorporate all the formulation components, preventing the formation of lumps, segregation, or irregular concentrations of the additives, which could compromise the stability and performance of the final coating. This property ensures that functional additives, such as flame retardants, plasticizers, and stabilizers, are evenly distributed throughout the polymer matrix, optimizing their performance in terms of fire resistance, flexibility, and durability.

Furthermore, “optimal adhesion” refers to the ability of the base resin to form a cohesive and stable interface with the underlying layers of the cable, ensuring a strong bond resistant to sliding, detachment, or delamination during cable handling, installation, and operation. Optimal adhesion is essential to prevent premature insulation failure and maintain the mechanical and flame-retardant protection of the coating at all times.

On the other hand, “adequate mechanical strength” refers to the material's ability to withstand tensile, compressive, and bending stresses without fracturing or significantly degrading over time. This property ensures that the coating maintains its structural integrity even under challenging installation conditions, such as passage through narrow ducts or exposure to thermal and mechanical variations throughout its service life.
B) At least one plasticizer, which, once included in the at least one base resin previously described, advantageously and substantially reduces the coefficient of friction, thus facilitating the sliding of the cable—to which the final coating of the present invention is applied—during its installation.

In one embodiment, the at least one plasticizer is any selected from the group comprising Trioctil Trimellitate, Dioctyl Adipate, Diisononyl Phthalate, Sebacic Acid Esters, combinations thereof and/or similar.

On the other hand, in a specific embodiment, at least one plasticizer is incorporated in proportions ranging from 5% to 45% of the composition.
C) At least one flame-retardant plasticizer, which, once included in the product or at least a base coating, provides essential flame-retardant properties, allowing the material to minimize the spread of flames in the event of ignition.

In one specific embodiment, at least one flame-retardant plasticizer lacks halogenated compounds.

On the other hand, in one embodiment, the at least one flame retardant plasticizer is any selected from the group comprising Non-Halogenated Alkyl Aryl, Phosphate Esters, Adipic Acid Esters, Citrates, Benzoates, Sebacic Acid Esters, Fumaric Acid Esters, Maleic Acid Esters, Terephthalic Acid Esters, Phosphonate Esters, Sulfonate Esters, combinations thereof and/or similar.

Also, in a specific embodiment, at least one flame-retardant plasticizer is used in a proportion ranging from 0.5% to 15%.
D) At least one fire-retardant plasticizer, which works in conjunction-primarily, with the at least one flame retardant plasticizer mentioned above; the at least one fire retardant plasticizer is capable of delaying ignition and the spread of fire, guaranteeing additional protection in critical situations, improving the safety of the installation without compromising the performance of the material.

The at least one fire retardant plasticizer, once incorporated into the at least one base resin, is able to modify the degree of esterification to optimize its effectiveness, achieving the above-advantageously-without negatively affecting the overall properties of the final coating.

Now, “modifying the degree of esterification” refers to adjusting the ratio between the ester groups and the other components of the formulation, which improves compatibility with the polymer matrix, increases thermal stability, and optimizes the dispersion of the additives in the mixture. In this way, the coating maintains its flexibility, mechanical strength, and insulating capacity, while also improving its performance when exposed to high temperatures and direct flames.

In one embodiment, the degree of esterification of the final coating is in a range from 0.75 to 0.98, which, for a person with ordinary knowledge in this field, will allow them to notice that, thanks to the composition and synergy of its components, an optimal balance between fire resistance and mechanical properties is obtained.

In one embodiment, the at least one fire-retardant plasticizer is halogen-free, meaning it does not contain chlorine, bromine, fluorine, or iodine in its composition, thus reducing the emission of toxic gases in case of fire and improving the environmental profile of the coating.

In one embodiment, the at least one flame retardant plasticizer is any selected from the group comprising Non-Halogen Triaryl Phosphate Ester Liquid, Alkyl Phosphate Esters, Aromatic Phosphate Esters, Mixed Phosphate Esters, Polyether Phosphates, Polyphenyl Phosphates, Alkyl Phenyl Phosphates, Phosphonate Derivatives, Phosphinate Derivatives, combinations thereof and/or similar.

More particularly, in one embodiment of the present invention, at least one fire retardant plasticizer is present in concentrations ranging from 0.4% to 10.0% of the total formulation.
E) At least one stabilizing lubricant, which is configurable, firstly, as a means of reducing the overall coefficient of friction of the coating and, therefore, of the cable once the final coating is placed over it according to the present invention, as well as functioning as a stabilizer, advantageously improving the flexibility of the coating, facilitating the sliding of the cable in confined spaces, and reducing the accumulation of mechanical stresses that could compromise the structure of the coating over time. Furthermore, its lubricating action minimizes abrasion between the cable and the internal surfaces of the conduits during installation, ensuring faster and more efficient placement.

In one embodiment, the at least one stabilizing lubricant is any selected from the group comprising epoxidized soybean oil (ESBO), glycerol monostearate (GMS), calcium stearate, zinc stearate, stearic acid, chlorinated paraffins, polyethylene wax, Montana wax, Fischer-Tropsch wax, aliphatic polyols, benzoic acid, organic phosphites, metallic salts of fatty acids (such as and not limited to barium, cadmium, and magnesium metallic stearates), and vegetable fatty acid esters; combinations thereof and/or similar.

Additionally, in one embodiment of the present invention, the at least one stabilizing lubricant is present in a range from 0.5% to 5.0%.
F) At least one thermal stabilizer, which is configurable to provide protection to both the at least one base resin and the overall composition against thermal degradation that may occur during processing and under high temperature operating conditions or during an emergency (e.g., a fire).

Moreover, the inventors have found that incorporating at least one thermal stabilizer with the various coating components of the present invention results in the coating having improved mechanical and structural properties, even in demanding operating environments, which substantially contributes to the object of the invention, since, as previously mentioned, the synergy resulting from the strategic combination of the present invention makes both the mechanical and fire and flame resistance properties stand out, as also demonstrated in the examples shown later in this document.

In one embodiment, the at least one thermal stabilizer is any selected from the group comprising PVC stabilizer, calcium and zinc salt-based stabilizers, phosphite esters, tin compounds, vegetable oil epoxides, combinations thereof and/or similar.

In an optional embodiment, the at least one thermal stabilizer further comprises metallic or organic compounds selected from the group comprising calcium, magnesium, barium and zinc derivatives, as well as organophosphorus compounds and specialized epoxides, combinations thereof and/or similar compounds; in this embodiment, the incorporation of metallic and organic compounds such as those previously referred to allows for improved thermal stability of the coating, minimizes polymer degradation under extreme temperature conditions and extends the cable's service life, ensuring reliable performance even in high thermal stress applications.

Additionally, according to one embodiment, the at least one thermal stabilizer is found in a proportion in a range between 1.0% and 15%.
G) At least one flame retardant, which is configurable to, when acting synergistically with the other components comprising the present invention, provide robust protection against ignition and the spread of fire.

It should be noted that, thanks to the advantageous incorporation of at least one flame retardant, and mainly due to the synergy mentioned throughout this application, the coating resulting from the present invention is able to achieve the FT4 classification, whereby said coating is able to effectively contain the advance of flames in situations of direct or adjacent ignition.

In one embodiment, the at least one flame retardant is any selected from the group comprising aluminum trihydroxide (ATH), magnesium hydroxide (MDH), aluminum oxide base, sepiolite base, calcium hydroxide, borates, silicates, phosphates, melamine and their derivatives, combinations thereof and/or similar.

Additionally, in a preferred embodiment, the at least one flame retardant is incorporated in a particle size ranging from 0.1 μm to 50 μm.

On the other hand, in an optional embodiment, the at least one flame retardant comprises at least one surface treatment selected from the group comprising silane coatings, fatty acid treatments, phosphate and/or sulfonate modifications, combinations thereof and/or similar; said at least one surface treatment allows for optimizing the dispersion and effectiveness thereof in the at least one base resin, in addition to reducing the migration of the compound within the polymer matrix, improving the thermal and mechanical stability of the coating.

In one embodiment, the at least one flame retardant is integrated into the formulation in a range from 1.0% to 20%.

Likewise, in one embodiment, the at least one flame retardant further comprises at least one combustion retardant selected from the group comprising Antimony Trioxide, Zinc Hydroxide, Molybdenum Oxide, Boron, Nitrogen and Phosphorus derivatives, combinations thereof and/or similar.

In said embodiment, the inclusion of any of the aforementioned flame retardants advantageously maximizes protection against the spread of fire, working in conjunction with the other components to ensure an effective response to possible ignition sources, reducing heat emission, generating a physical barrier and promoting the formation of a charred layer that insulates the underlying material, further enhancing the effectiveness of the other inorganic retardants present in the composition.

In this sense, by “further enhancing the effectiveness of the other inorganic retardants present in the composition” refers to the synergistic effect of the included compounds, in which the combination of retardants allows for optimizing heat absorption, reducing the rate of thermal degradation and improving the structural stability of the coating under fire conditions.

In one specific embodiment, the at least one combustion retardant is incorporated in quantities within the range of 1.0 to 15.0%.

Furthermore, according to one embodiment of the present invention, the at least one flame retardant, and/or the at least one combustion retardant previously described is in any selected presentation from the group comprising fine granulated powder, liquid dispersion, microencapsulated, combinations thereof and/or similar.

In an additional embodiment, the at least one flame retardant, and/or the at least one combustion retardant have a particle size in a range from 0.05 μm to 100 μm, as well as a purity in a range from 90% to 99.9%.
H) At least one auxiliary lubricant and stabilizer, the purpose of which is to substantially facilitate the processing of the coating of the present invention, particularly by contributing to obtaining a uniform surface finish.

In this way, the use of at least one auxiliary lubricant and stabilizer advantageously reduces the occurrence of defects during extrusion and ensures a homogeneous distribution of the additives in the final coating.

In one embodiment, the at least one auxiliary lubricant and stabilizer is any selected from the group comprising calcium stearate, zinc stearate, magnesium stearate, metallic salts of fatty acids, saturated and unsaturated fatty acids, combinations thereof and/or similar.

In addition, in a specific embodiment, the at least one auxiliary lubricant and stabilizer is present in the formulation in a range from 0.1% to 5.5%.

In one embodiment, the at least one auxiliary lubricant and stabilizer is in any state selected from the group comprising fine powder form, granules, liquid form or tablets, combinations thereof and/or similar.

Optionally, in one embodiment, the at least one auxiliary lubricant and stabilizer is subjected to at least one surface treatment selected from the group comprising plasma treatment, metal oxide coating, and chemical modification with acyl reagents, combinations thereof, and/or similar treatments. The function of such surface treatment applied to the at least one auxiliary lubricant and stabilizer is to improve the dispersion of the additives within the base polymer, reduce the tendency to agglomerate, and ensure greater thermal stability and resistance to aging of the coating during its service life.
I) At least one polymer-based additive, which helps to reduce the coefficient of friction on the coating surface, facilitating cable sliding and speeding up installation in confined spaces.

It is worth mentioning that the integration of at least one polymer-based additive contributes synergistically to optimizing the mechanical and sliding properties of the coating without affecting its flame-retardant resistance.

In this sense, by “optimizing the mechanical and sliding properties of the coating without affecting its fire resistance” it should be understood that the addition of said additive improves the sliding capacity of the coating, allowing its installation to be faster and more efficient, without compromising the essential properties of the coating, such as its fire resistance, its thermal stability and its structural integrity under high temperature conditions, which is crucial to maintain its functionality in fire situations.

In one embodiment, the at least one polymer-based additive is any additive selected from the group comprising Low Molecular Weight Polyethylene, Polypropylene (PP), High Density Polyethylene (HDPE), Low Density Polyethylene (LDPE), Polyamides, and their derivatives, combinations thereof and/or similar.

In addition, according to a specific embodiment, the at least one polymer-based additive is incorporated in concentrations ranging from 0.1 to 3.5%.

Additionally, the at least one polymer-based additive is present in any form selected from the group comprising powder, dispersed additive, pellets, microparticles, dispersion liquids, combinations thereof and/or similar.
J) At least one antioxidant, which, when incorporated into the formulation of the present invention, protects it against oxidative degradation during processing and throughout the useful life of the cable to which the coating is applied.

The presence of at least one antioxidant helps to advantageously prevent the loss of mechanical and aesthetic properties of the coating, especially in operating environments with adverse conditions or in emergency situations.

In one particular embodiment, the at least one antioxidant is any selected from the group comprising hindered phenols or phosphites, BHT (butylhydroxytoluenes), BHA (butylhydroxyanisole), phosphites such as tris(2,4-di-tert-butylphenyl)phosphite or bis(2,4-di-tert-butylphenyl) phosphite, ascorbic acid (vitamin C), oxalic acid, octyl gallate (OG) or ethyl gallate, combinations thereof and/or similar.

Furthermore, in one embodiment, the at least one antioxidant is incorporated into the formulation in a range from 0.1% to 4.0%.
K) At least one UV Light Stabilizer, which is capable of providing long-lasting protection against degradation induced by ultraviolet radiation, ensuring that the coating maintains its sliding properties and fire resistance during long periods of exposure to aggressive environmental conditions.

By incorporating the at least one UV light stabilizer into the formulation of the present invention, it is advantageously possible to extend the service life of the cable on which the resulting coating is applied, especially in outdoor applications or in environments where solar radiation is intense.

In one embodiment, the at least one UV light stabilizer is any selected from the group comprising hindered amines (HALS), bisphenol A derivatives, substituted styrenes, polycyclic benzene compounds, benzotriazoles, triazines, hydroxybenzophenones, oxalanilides, carboxylic acid compounds, phosphites, and arylsulfuric acids, combinations thereof and/or similar.

Likewise, in one embodiment, the at least one UV light stabilizer according to the present invention is incorporated in quantities ranging from 0.1 to 6.0%.

Taken together, the combination and synergy of these components give the invention technical properties that overcome the limitations of conventional materials, providing a comprehensive solution that optimizes both the cable installation process in confined spaces and safety against ignition and fire spread. Each element has been carefully selected and dosed to ensure that the coating not only facilitates sliding and reduces wear during installation, but also acts efficiently against potential ignition sources, protecting the integrity of the electrical system and contributing to the overall safety of the infrastructure.

On the other hand, it is important to mention that the coating resulting from the present invention is configurable for use with any type of cable selected from the group comprising low-voltage cables such as, but not limited to, power cables, telecommunications cables, control cables, and electrical distribution cables in residential, commercial, and industrial installations; medium-voltage cables such as, but not limited to, cables used in electrical distribution networks, cables for underground power installations, cables for medium-voltage transmission systems, and interconnection cables for electrical substations; high-voltage cables such as, but not limited to, cables for high-voltage transmission lines, cables for interconnections between power generation plants, cables in high-voltage networks for telecommunications or large-scale electrical systems; and applicable in any field such as, but not limited to, the electrical sector, telecommunications, control and automation systems, industrial installations, renewable energy, transport infrastructure, and any other area that requires insulation and protection solutions for cables exposed to extreme temperature conditions, UV radiation, or fire risk.

Having fully described the different compounds that conform to the coating of the present invention presented below in Table 1, the methodology for generating said coating (first formulation described, Table 1) is described below, as well as the methodology for applying the coating generated by the present invention to a voltage cable (second formulation described, Table 2).

### Examples

Having thoroughly explained each of the features of the present invention, as well as described the different examples of embodiments that the invention adopts, bearing in mind that said examples of embodiments described in this application should not be taken or interpreted in any way as limitations of the present invention, on the contrary, said examples of embodiment are intended in every sense to support the understanding of the operation of the system being provided by the user and to allow a comprehensive understanding of how the composition with the plurality of specific components described in the present invention; the invention is capable of, in addition to providing a novel composition with the ability to generate a highly sliding voltage cable coating, but also, with said added value, the composition is able to offer a solution or provide an advantageous response according to the needs set forth herein.

Having said that, the following will describe in more detail these examples of non-limiting embodiments:

Taking the above into account, a series of compound formulations specifically designed for halogenated thermoplastic jackets made by the inventors are described below.

As an example of a non-limiting embodiment, we have the formula of the present invention (referenced as Formulation 1.1) for a thermoplastic coating for medium voltage cables that offers fire resistance improvement properties with a type FT4 classification.

Table 1 below presents the quantities in mass units in Kg and dimensionless units of phr (per hundred of resin). It is important to mention that the term phr is found in specialized technical documents on the subject and is commonly used throughout this document.

TABLE 1
Fire resistance improvement formula with FT4 classification.

| Group | Raw material | Kg | phr |
|---|---|---|---|
| 1 | Resin Grade 1300-n | 75 | 100 |
| 2 | TOTM | 22.5 | 30 |
| 2 | Santicizer 2148 | 6 | 8 |
| 2 | Santicizer 154 | 6 | 8 |
| 2 | Epoxidized Soybean Oil | 1.5 | 2 |
| 1 | Plastitab BL 2187 | 6 | 8 |
| | Apyral 60D/ Micral 1500 | 7.5 | 10 |
| 3 | Portaflame C30 | 6 | 8 |
| | Adins Clay Sil-1 fireproof | 3 | 4 |
| 3 | Antimony Trioxide | 4.5 | 6 |
| 3 | Calcium Stearate | 0.8 | 1 |
| 3 | Epolene N14P | 0.8 | 1 |
| 1 | Irganox 1010 | 0.3 | 0.4 |
| 1 | Tinuvin / Hostavin | 0.5 | 0.6 |

Note:
This 1.1 “base” formulation meets the FT4 classification test.

Table 1 shown above, as well as the other tables presented throughout this document, contains a series of materials with trade names; although these raw materials of the present formulation are classified by polymer base, in this work it refers to PVC (polyvinyl chloride), mineral fillers, antioxidants, plasticizers and UV protection agents.

Once the composition described above in this document has been obtained, a cable with the specified coating is produced using a simple extrusion method. The manufacturing process for the voltage cable coating is described below in the following steps:
Preparation of materials: The precise dosage of the raw material is carried out.
Mixing and homogenization: A high shear mixer is used to achieve a uniform distribution of the additives.
Extrusion: The mixture is heated and extruded over the voltage wire through an extrusion nozzle by an extrusion machine.
Cooling and solidification: Controlled cooling systems are used to prevent deformations in the coating.
Winding and cutting: The coated cable is cut and wound according to specifications.

Another example is Formulation 1.2 for a thermoplastic PVC coating for medium voltage cables that offers improved sliding properties and fire resistance, achieving an FT4 classification.

TABLE 2
Formulation 1.2. Improvement formula for a thermoplastic
PVC fire-resistant coating with FT4 classification.

| Raw material | Kg | phr |
|---|---|---|
| PVC Resin Grade 1300F | 228 | 100 |
| TOTM | 41.04 | 18 |
| DIDA | 34.20 | 15 |
| Epoxidized soybean oil | 4.56 | 2 |
| Stabikem 2187 | 23.94 | 10.50 |
| Aurostab 55 | 1.20 | 0.53 |
| Calcium stearate | 2.28 | 1.0 |
| Chlorinated paraffin S-52 | 22.80 | 10.0 |
| Campine Antimony Trioxide | 13.68 | 6.0 |
| Decabromide | 11.40 | 5.0 |
| Licowax C Micropowder | 0.57 | 0.25 |
| UV(Tinuvin)(Hostavin) | 1.14 | 0.50 |
| Struktol TR-141-OC | 4.56 | 2.0 |
| Zinc borate ZB-23335 | 9.12 | 4.0 |
| Uniplex FR45 | 22.80 | 10.0 |
| Irganox / Songnox 1010 | 0.57 | 0.25 |
| Apyral 60D/ Micral 1500 | 79.80 | 35 |

This Formulation 1.2 has a higher category than Formulation 1.1, because it has an additive that helps the flame retardant to more efficiently create synergy, thus providing greater fire resistance protection.

The physical properties for a thermoplastic jacket are presented in Table 3 below.

TABLE 3
Results of the physical properties of the compound
for a material with a thermoplastic PVC jacket.

| | Properties | Value |
|---|---|---|
| | Tensile strength (psi) | 1500 |
| Initials | Elongation (%) | 100 |
| Air | Effort retention, minimum % | 70 |
| | Elongation retention, % minimum | 50 |
| Ar | Effort retention, %, minimum | 70 |
| | Retention of elongation, %, minimum | 50 |
| SunRes | Effort retention, %, minimum | 80 |
| | Retention of elongation, %, minimum | 80 |
| | Maximum deformation, % | 50 |

On the other hand, FIG. 1 presents five different types of cable jackets in 4/0 AWG. In this figure, the temperature (° C.) refers to the duct temperature for each of the samples presented. -FT4 UL 24N 16-05-2018, FT4 EXN 14-05-2018.-Red line, blue line, green line, yellow line, and black line.

FIG. 1 shows the preparation of an FT4 type flame sample according to UL Standard 1072 for a 1/0 AWG wire.

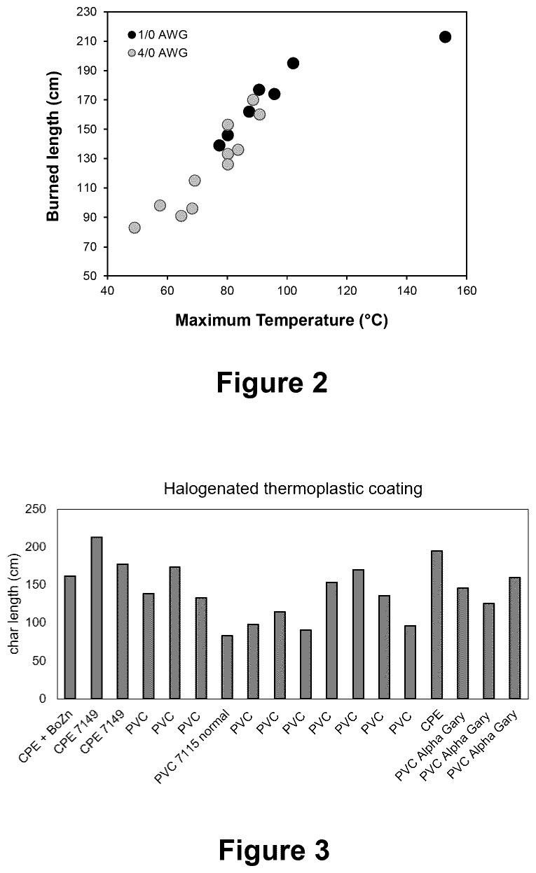

In FIG. 2, after 20 minutes of operation, the carbonization length on the thermoplastic jacket of the chlorinated halogen class increases, and it can be observed that as the operating temperature increases, the operating length increases for both gauges presented; however, this result is more than evident, even to the point of being obvious, although it is important to mention that, according to UL Standard 1685, one of its sections stipulates that the maximum tolerance operating length is 150 cm (1500 mm), and exceeding this length is considered a non-conforming product result for various PVC and CPE thermoplastic jackets.

On the other hand, it is important to mention the results obtained in the set of tests presented above.

In the same FIG. 2, a char length is presented depending on the different cable jackets for 1/0 and 4/0 AWG gauges, respectively. The graph shows that at distances, and specifically at a distance of 150 cm, the formation of char for all samples of gauges with halogenated thermoplastic jacket within the given temperature ranges. This char formation result is due to the composition of the jacket material and its thermal response to elevated temperatures in which were evaluated, within the studied time range. are the factors contributing to the protective layer. However, the protective layer's is due to the concentration of inorganic compounds such as flame retardants; for example, aluminum-based compounds, magnesium silicates, and antimony trioxide, to mention the most relevant in the PVC formulation system, which play a significant role in char formation. Nevertheless, this char formation is due to the chemical reaction between antimony trioxide and the other components, which, due to the properties of the thermoplastic material, degrades; this chemical reaction describes the carbonization mechanism as shown below.

An important feature in this process is the flame temperature, since it has a heat capacity of 70,000 BTU, as this amount of heat is sufficient to induce the formation of carbonization in thermoplastic jackets and to react with the cable components. In addition, the presence of char formation has been observed in 4/0 AWG electrical cables.

On the other hand, for 1/0 AWG gauges it is the opposite case, it exceeds the reference length, and the result is more than evident and one of the possible reasons that the test is not satisfactory is due to the dimensions of the gauge and the thickness thereof.

In the case of 4/0 AWG gauge, in PVC jackets with EPR insulation, this result of compliance with what is stipulated in the Standard is more than evident.

With reference to FIG. 5, it is shown the classic behavior of the FT4 flame test (blue line); on the other hand, the typical smoke emission rate curve as a function of the studied time of 2000 s, for a given gauge (red line) indicates the gas escape interval, of a halogenated thermoplastic (PVC) jacket with cross-linked ethylene-propylene rubber (EPR) copolymer insulation. Although it is observed that increasing the rate above 90° C., the traditional behavior is more than evident, this is because the flame temperature is sufficiently incandescent to accelerate char formation. However, the result reported in 2019 (reference) concludes that in thermoplastic jackets. However, the NMX-498-ANCE Standard, clearly explains that for a positive result; that is, a test that meets the specifications according to the Official Mexican Standard must be less than 150 cm or 59 in.

On the other hand, the formation of fumes as a chemical reaction and degradation of the polymeric material and its components in the 4/0 AWG cable.

This work presents a historical perspective on the results obtained from the evaluation of the “FT4” vertical tray cable test, which measures the flame-retardant properties of conductor cables with known dimensions and characteristics. The results presented are for internal products dating from 2014 to 2017; for example, the following products can be found: Formulation 1.3, Formulation 1.4, Formulation 1.5, Formulation 1.6, and Formulation 1.7, respectively.

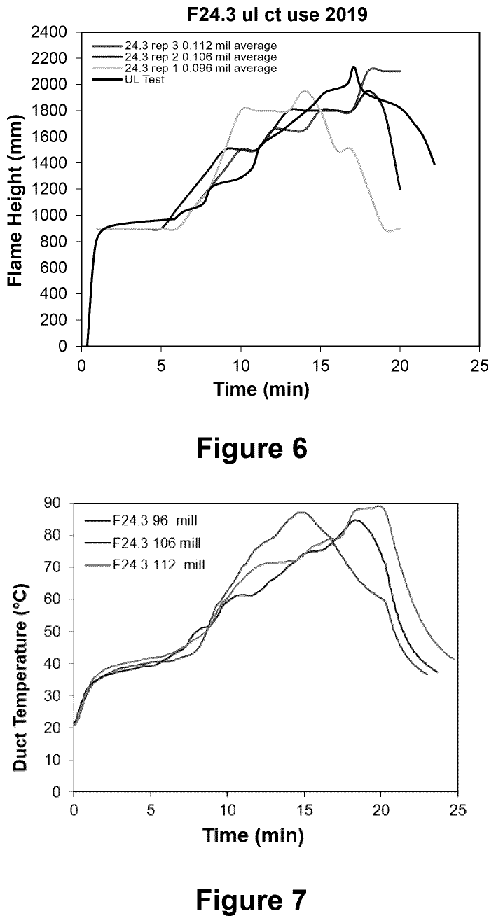

FIG. 6 below presents a graph of the results obtained from a historical data set for five different types of products.

It is important to mention that the products from Formulation 1.3 to Formulation 1.7 presented are not available.

Another important result comes from tests conducted on thicknesses greater than 90 mils. This characteristic, as shown in this result, was observed with thicknesses of 96, 106, and 112 mils. respectively. It can be seen in FIGS. 6 and 7 that, for these thicknesses, the length of the char, as this term is known in the cable industry and is a concept accepted by national and international standards on the subject.

Many modifications and other embodiments of the invention will occur to a person skilled in the art to which the invention belongs, having benefited from the teachings presented in the preceding description and associated drawings. It should therefore be understood that the invention is not to be limited to the specific embodiments and examples described, but that modifications and other embodiments are intended to be included within the scope of the appended claims. Although specific terms are used herein, they are used only in a generic and descriptive sense and not for limiting purposes. Also, It should also be understood that the materials from which the various components comprising the invention described herein may be manufactured, the geometries, dimensions, arrangements, and other elements may vary without departing from the scope and spirit of the invention, and therefore the embodiments referred to should not be considered limiting.

1. A composition for generating a thermoplastic coating with improved sliding and fire resistance properties for cables, comprising:
a) at least one base resin;
b) at least one plasticizer;
c) at least one flame-retardant plasticizer;
d) at least one fire-retardant plasticizer;
e) at least one stabilizing lubricant;
f) at least one thermal stabilizer;
g) at least one flame retardant;
h) at least one auxiliary lubricant and stabilizer;
i) at least one polymer-based additive;
j) at least one antioxidant; and
k) at least one UV light stabilizer;
characterized in that
the at least one base resin is present in a range from 30% to 60% of the total composition;
the at least one plasticizer is present in a range from 5% to 45% of the total composition;
the at least one flame-retardant plasticizer is present in a range from 0.5% to 15% of the total composition;
the at least one flame retardant plasticizer is present in a range from 0.4% to 10.0% of the total composition;
the at least one stabilizing lubricant is present in a range from 0.5% to 5.0% of the total composition;
the at least one thermal stabilizer is present in a range from 1.0% to 15% of the total composition;
the at least one flame retardant is present in a range from 1.0% to 20% of the total composition;
the at least one auxiliary lubricant and stabilizer is present in a range from 0.1% to 5.5% of the total composition;
the at least one polymer-based additive is present in a range from 0.1% to 3.5% of the total composition;
the at least one antioxidant is present in a range from 0.1% to 4.0% of the total composition;
and the at least one UV light stabilizer is present in a range from 0.1% to 6.0% of the total composition.

2. The composition according to claim 1, wherein the at least one base resin is any selected from the group comprising high-quality polyvinyl chloride (PVC), cross-linked polyethylene (XLPE), high-density polyethylene (HDPE), low-density polyethylene (LDPE), ethylene-vinyl acetate copolymers (EVA), technical polyamides, combinations thereof and/or similar materials.

3. The composition according to claim 1, wherein the at least one base resin comprises a viscosity in a range from 200 to 500 poises.

4. The composition according to claim 1, wherein the at least one base resin comprises a density in the range of 1.2 to 1.5 g/cm³.

5. The composition according to claim 1, wherein the at least one plasticizer is any selected from the group comprising Trioctil Trimellitate, Dioctyl Adipate, Diisononyl Phthalate, Sebacic Acid Esters, combinations thereof and/or similar.

6. The composition according to claim 1, wherein the at least one flame-retardant plasticizer is free of halogenated compounds.

7. The composition according to claim 6, wherein the at least one flame retardant plasticizer is any selected from the group comprising Non-Halogenated Alkyl Aryl, Phosphate Esters, Adipic Acid Esters, Citrates, Benzoates, Sebacic Acid Esters, Fumaric Acid Esters, Maleic Acid Esters, Terephthalic Acid Esters, Phosphonate Esters, Sulfonate Esters, combinations thereof and/or similar.

8. The composition according to claim 1, wherein the at least one flame retardant plasticizer is halogen-free and is any selected from the group comprising Non-Halogen Triaryl Phosphate Ester Liquid, Alkyl Phosphate Esters, Aromatic Phosphate Esters, Mixed Phosphate Esters, Polyether Phosphates, Polyphenyl Phosphates, Alkyl Phenyl Phosphates, Phosphonate Derivatives, Phosphinate Derivatives, combinations thereof and/or similar.

9. The composition according to claim 1, wherein the composition has a degree of esterification in a range from 0.75 to 0.98.

10. The composition according to claim 1, wherein the at least one stabilizing lubricant is any selected from the group comprising epoxidized soybean oil (ESBO), glycerol monostearate (GMS), calcium stearate, zinc stearate, stearic acid, chlorinated paraffins, polyethylene wax, montana wax, Fischer-Tropsch wax, aliphatic polyols, benzoic acid, organic phosphites, metallic salts of fatty acids, vegetable fatty acid esters, combinations thereof and/or similar.

11. The composition according to claim 1, wherein the at least one thermal stabilizer is any selected from the group comprising PVC stabilizer, calcium and zinc salt-based stabilizers, phosphitic esters, tin compounds, vegetable oil epoxides, combinations thereof and/or similar.

12. The composition according to claim 11, wherein the at least one thermal stabilizer further comprises metallic or organic compounds selected from the group comprising calcium, magnesium, barium and zinc derivatives, as well as organophosphorus compounds and specialized epoxides.

13. The composition according to claim 1, wherein the at least one flame retardant is any selected from the group comprising aluminum trihydroxide (ATH), magnesium hydroxide (MDH), aluminum oxide base, sepiolite base, calcium hydroxide, borates, silicates, phosphates, melamine and its derivatives, combinations thereof and/or similar.

14. The composition according to claim 13, wherein the at least one flame retardant comprises a synergistic combination of magnesium hydroxide (MDH), aluminum oxide base, aluminum trihydrate (ATH), and a functionalized sepiolite base.

15. The composition according to claim 13, wherein the at least one flame retardant comprises a particle size in a range from 0.1 μm to 50 μm.

16. The composition according to claim 13, wherein the at least one flame retardant comprises at least one surface treatment selected from the group comprising silane coatings, fatty acid treatments, phosphate and/or sulfonate modifications, combinations thereof and/or similar.

17. The composition according to claim 1, wherein the at least one flame retardant further comprises at least one combustion retardant selected from the group comprising antimony trioxide, zinc hydroxide, molybdenum oxide, boron, nitrogen and phosphorus derivatives, combinations thereof and/or similar.

18. The composition according to claim 17, wherein the at least one combustion retardant is present in a range from 1.0% to 15.0% of the total composition.

19. The composition according to claim 17, wherein the at least one flame retardant has a purity in a range from 90% to 99.9%.

20. The composition according to claim 17, wherein the at least one flame retardant has a particle size in a range from 0.05 μm to 100 μm.

21. The composition according to claim 17, wherein the at least one flame retardant is presented in any form selected from the group comprising fine granulated powder, liquid dispersion, microencapsulated, combinations thereof and/or similar.

22. The composition according to claim 1, wherein the at least one auxiliary lubricant and stabilizer is any selected from the group comprising calcium stearate, zinc stearate, magnesium stearate, metallic salts of fatty acids, saturated and unsaturated fatty acids, combinations thereof and/or similar.

23. The composition according to claim 22, wherein the at least one auxiliary lubricant and stabilizer comprises at least one surface treatment selected from the group comprising plasma treatment, metal oxide coating, and acyl reagent chemical modification.

24. The composition according to claim 22, wherein the at least one auxiliary lubricant and stabilizer is in any state selected from the group comprising fine powder form, granules, liquid form, or tablets.

25. The composition according to claim 1, wherein the at least one polymer-based additive is any selected from the group comprising Low Molecular Weight Polyethylene, Polypropylene (PP), High Density Polyethylene (HDPE), Low Density Polyethylene (LDPE), Polyamides, combinations thereof and/or similar.

26. The composition according to claim 1, wherein the at least one antioxidant is any selected from the group comprising hindered phenols, phosphites, butylhydroxytoluenes (BHT), butylhydroxyanisole (BHA), tris(2,4-di-tert-butylphenyl) phosphite, bis(2,4-di-tert-butylphenyl) phosphite, ascorbic acid, oxalic acid, octyl gallate, ethyl gallate, combinations thereof and/or similar.

27. The composition according to claim 1, wherein the at least one UV light stabilizer is any selected from the group comprising hindered amines (HALS), bisphenol A derivatives, substituted styrenes, polycyclic benzene compounds, benzotriazoles, triazines, hydroxybenzophenones, oxalanilides, carboxylic acid compounds, phosphites, arylsulfuric acids, combinations thereof and/or similar.

28. A method for generating a cable with a coating of improved sliding properties and fire resistance, the method using the composition according to claim 1; the method comprising the steps of:
a) preparation of materials, comprising carrying out the precise dosage of the raw material of the composition;
b) mixing and homogenization, comprising processing the dosed raw material in a mixer to achieve a uniform distribution of the components;
c) extrusion, comprising heating and extruding the homogenized mixture resulting from step b) over a conductive cable through an extrusion nozzle;
d) cooling and solidification, comprising applying controlled cooling to the coated cable resulting from step c); and
e) winding and cutting, comprising cutting and winding the cooled coated cable.

29. The method according to claim 28, wherein in step b) the mixer used is a high shear mixer.

30. The method according to claim 28, wherein step c) of extrusion is performed by an extrusion machine controlling the temperature and extrusion speed.

31. The method according to claim 28, wherein step d) of cooling is carried out by controlled cooling systems to avoid deformations in the coating.

32. The method according to claim 28, wherein the coating generated after step d) achieves a fire resistance classification of FT4.

33. The method according to claim 32, wherein the coating has a char length of less than 150 cm after exposure to flame.

34. A use of the composition according to claim 1, for the manufacture of a coating on selected cables from the group comprising low voltage cables, medium voltage cables and high voltage cables.

35. The use according to claim 34, wherein the low voltage cables are selected from the group comprising power cables, telecommunications cables, control cables, and electrical distribution cables in residential, commercial, and industrial installations.

36. The use according to claim 34, wherein the medium voltage cables are selected from the group comprising cables used in electrical distribution networks, cables for underground power installations, cables for medium voltage transmission systems, and interconnection cables for electrical substations.

37. The use according to claim 34, wherein the high-voltage cables are selected from the group comprising cables for high-voltage transmission lines, cables for interconnections between power generation plants, cables in high-voltage networks for telecommunications or large-scale electrical systems.

38. The use according to claim 34, applicable in any field selected from the group comprising the electrical sector, telecommunications, control and automation systems, industrial installations, renewable energy and transport infrastructure.
